(19) United States
(12) Patent Application Publication
(10) Pub. No.: US 2003/0116889 A1
(43) Pub. Date: Jun. 26, 2003

(54) Molding machine for hollow article and molding method for the same

(76) Inventor: Akira Toshikawa, Shiga (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/323,944

(22) Filed: Dec. 20, 2002

(30) Foreign Application Priority Data
Dec. 25, 2001 (JP) 2001-391707
Oct. 15, 2002 (JP) 2002-300152

(51) Int. Cl. B29C 49/20

(52) U.S. Cl. 264/512; 425/503

(57) ABSTRACT

A molding machine for molding a hollow article which has at least two laminated layers. The molding machine comprises: a pair of molds 1, 2 capable of opening and closing; a core pin 3 which is disposed between the molds 1, 2 and which allows a bottom layer material 51 to fit on a peripheral surface of the core pin 3; a parison transfer device 4 which supplies a parison 42, as a top layer material, between the bottom layer material 51 and the molds 1, 2; and a pair of slide members 13 disposed in at least one of the molds 1, 2 and movable to and away from the core pin 3. The molds 1, 2, the slide members 13 and the core pin 3 are arranged to define a space which corresponds to the hollow article, when the molds are closed.

### BACKGROUND OF THE INVENTION

1. Field of the Invention

The present invention relates to a molding machine and a molding method for a hollow article which has at least two layers.

2. Related Art

Until now, there is no established technique for molding a multi-layered hollow article (e.g. a two-layered hollow article). For example, injection molding of a multi-layered hollow article faces the following problems.

In order to make a hollow article (e.g. a pipe joint) by injection molding, it is necessary to consider mold release characteristics carefully, which complicates the molding process. Besides, since a molten resin needs to be injected into a mold cavity under high pressure, the total molding cost including the mold production cost amounts to a huge sum. In terms of profitability, etc., these restrictions have hampered technical development.

### SUMMARY OF THE INVENTION

While the conventional techniques are not practical, there are strong demands to establish a novel technique for molding a hollow article.

A molding machine according to the present invention is a machine for molding a hollow article which has at least two laminated layers. This molding machine comprises: a pair of molds which are capable of opening and closing; a core pin which is disposed between the molds and which allows a bottom layer material to fit on a peripheral surface of the core pin; a parison transfer device which supplies a parison, as a top layer material, between the bottom layer material and the molds; and a moving unit which is disposed in at least one of the molds and which moves to and away from the core pin. When the pair of molds are closed, the molds, the moving unit and the core pin are arranged to define a space which corresponds to the hollow article.

In the molding machine for a hollow article according to the present invention, the peripheral surface of the core pin includes a spiral groove, and inner surfaces of the molds and the moving unit have a spiral ridge to be received and engaged by the spiral groove.

In the molding machine for a hollow article according to the present invention, the moving unit is composed of a pair of slide members which are slidable to and away from the core pin.

In the molding machine for a hollow article according to the present invention, a spiral ridge is defined between adjacent spires of the groove formed in the core pin, and a top surface of this spiral ridge is provided with an additional groove which extends continuously or intermittently along the ridge.

A molding method according to the present invention is a method for molding a hollow article which has at least two laminated layers. This molding method comprises the steps of: placing and fitting an annular bottom layer material on a peripheral surface of a core pin which is disposed at the center of a pair of molds; supplying a parison around an outer periphery of the bottom layer material so as to enclose the core pin and the bottom layer material by the parison; closing the molds, except a moving unit which is provided in at least one of the molds, thereby making a partially interrupted molding surface; and moving the moving unit in order to complete the molding surface, thereby molding a hollow article.

The molding method for a hollow article according to the present invention further comprises the step of stretching the parison in an axial direction, with an end of the parison gripped. This stretching step is performed between the parison supply step and the mold closing step.

The molding method for a hollow article according to the present invention further comprises: forming a spiral groove in the peripheral surface of the core pin; and providing a spiral ridge to be received and engaged by the spiral groove, on inner surfaces of the molds and the moving unit. The spiral groove and the spiral ridge are provided in such a manner that, when molded, the hollow article has a spiral groove formed in an outer peripheral surface thereof and a spiral ridge formed on an inner peripheral surface thereof.

In the molding method for a hollow article according to the present invention, the hollow molded article is released from the core pin by rotating the core pin.

In the molding method for a hollow article according to the present invention, the bottom layer material is a material having waterproof performance.

### BRIEF DESCRIPTION OF THE DRAWINGS

FIG. 1 is a perspective view of a molded

FIG. 2 is a cross-sectional view showing a profile of the molded article.

FIG. 3 is a side view showing the schematic structure of a molding machine of the present invention.

FIG. 4 is a plan view showing a pair of molds and a core pin, with the molds open.

FIG. 5 is a cross-sectional view of a cavity which is defined between the molds and the core pin.

FIG. 6 is a plan view showing the molds and the core pin, with the molds closed.

FIG. 7 is a plan view showing the movement of a pair of slide members in the mold closing process.

FIG. 8 is a side view showing another example of the molding machine of the present invention.

FIG. 9 is a cross-sectional view of a cavity which is defined between the molds and the core pin.

FIG. 10 is a cross-sectional view showing another molded article.

FIG. 11 is a cross-sectional view showing a profile of the molded article.

### DESCRIPTION OF THE PREFERRED EMBODIMENTS

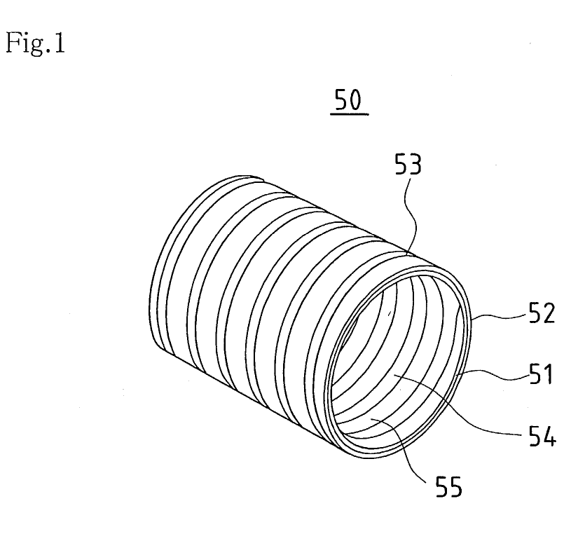

Embodiments of the present invention are hereinafter described with reference to the drawings. FIG. 1 shows an example of a molded article (an annular article) to be manufactured by a molding machine and a molding method for a hollow article according to the present invention.

A molded article 50 is a pipe joint for connecting an end of one pipe to an end of another pipe, and has a two-layered cylindrical structure. In this molded article 50, the bottom layer material is non-woven fabric 51 with waterproof performance, and the top layer material is a synthetic resin 52 which forms a parison to be fed by a parison transfer device as mentioned later.

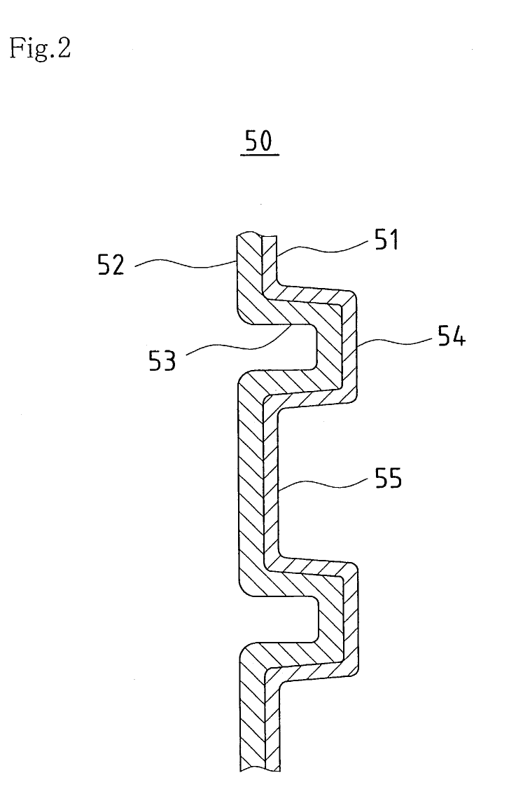

As illustrated in FIG. 1 and FIG. 2, the outer peripheral surface of the molded article 50 includes a spiral groove 53, and the inner peripheral surface has a spiral ridge 54 which matches the groove 53. Owing to the contour of the outer and inner peripheral surfaces, the inner peripheral surface of the molded article 50 is provided with a groove 55 as a thread, between adjacent spires of the spiral ridge 54.

Regarding the pipes to be connected by this joint, their outer peripheral surfaces are threaded at the connecting ends so as to be engageable with the thread in the molded article 50. The ends of these threaded pipes can be screwed into the molded article 50, so that the adjacent pipe ends are connected to each other via the pipe joint, that is, the molded article 50.

As detailed below, the molded article 50 is manufactured by a molding machine and a molding method for a hollow article according to the present invention.

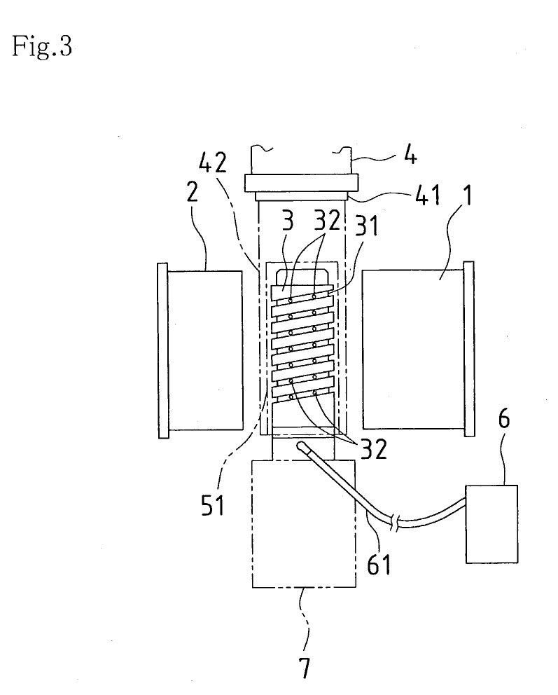

FIG. 3 shows the schematic structure of a molding machine.

The molding machine is constituted with a pair of molds 1, 2, a core pin 3 disposed between the molds 1, 2, and a parison transfer device 4 which locates above the core pin 3 in order to supply a parison into a cavity defined between the core pin 3 and the molds 1, 2.

The molds 1, 2 are transversely movable by means of a moving means such as a hydraulic cylinder (not shown). To open and close the molds, the core pin 3 and a parison exit 41 of the parison transfer device 4 are taken as the reference.

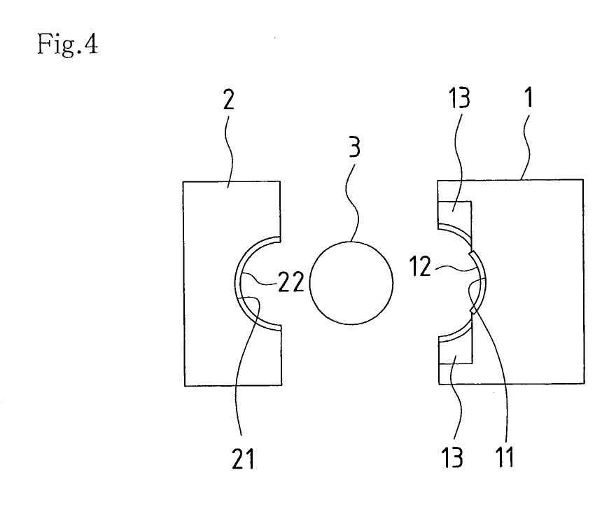

Turning to FIG. 4, the inner peripheral surfaces 11, 21 of the molds 1, 2 are processed such that a columnar chamber is defined at the center of the molds in the closed state. These inner peripheral surfaces 11, 21 are provided with ridges 12, 22 which make up a continuous spiral ridge together.

Still referring to FIG. 4, the mold 1 which defines a part of the above chamber is partially constituted with a pair of slide members 13 as a moving unit. The pair of slide members 13 are separately disposed at the front and back of the mold 1. By means of an actuator such as a motor or a telescopic cylinder, the slide members 13 are made slidable between the molding position where they form the chamber with the molds 1, 2 and the retracted position where the slide members 13 expand forwardly and backwardly in the mold 1.

The core pin 3 has a columnar shape which is slightly smaller than the chamber. The core pin 3 is provided with a spiral groove 31 which extends across the length of its outer peripheral surface. The groove 31 can receive and engage with the ridges 12, 22 when the molds 1, 2 are closed.

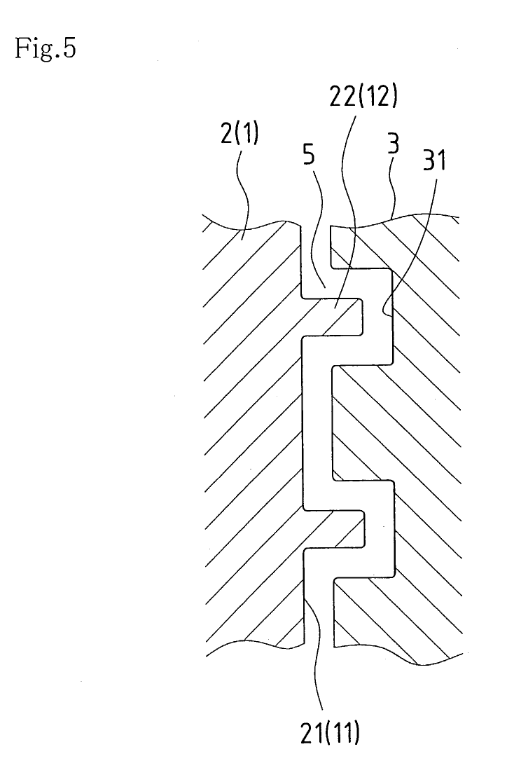

Thus, when the molds 1, 2 are closed with interposition of the core pin 3, a cavity (clearance) 5 in the form of the molded article 50 is provided between the molds 1, 2 and the core pin 3 as illustrated in FIG. 5.

The core pin 3 also includes a fitting means for fitting the non-woven fabric 51 on the outer peripheral surface of the core pin 3, when the nonwoven fabric 51 prepared in a cylindrical shape is placed around the core pin 3 in order to produce the molded article 50. In the fitting means, air holes 32 are formed through the bottom of the groove 31 and arranged to communicate with a communication passage (not shown) which extends within the core pin 3. The communication passage is connected to an external suction/blower device 6 via a hose 61.

The suction/blower device 6 is arranged to suck air from the air holes 32 to the suction/blower device 6 and to discharge air from the suction/blower device 6 through the air holes 32. Once the suction/blower device 6 is activated to suck air through the air holes 32, the non-woven fabric 51 placed around the core pin 3 can be sucked on its outer peripheral surface.

Although not illustrated, a chuck is disposed in the vicinity of the lower end of the core pin 3. When a parison 42 entirely encloses the outer peripheral surface of the core pin 3, the bottom end of the parison 42 is gripped by the chuck at the lower end of the core pin 3.

The parison transfer device 4 is a known device and supplies a parison 42 of synthetic resin which is heated and softened in an extruder (not shown). The parison 42 is supplied from the parison exit 41 onto the outer peripheral surface of the core pin 3 which locates between the molds 1, 2. The parison 42 coming out from the parison exit 41 is a so-called bottomless or endless tubular parison. The parison transfer device 4 can rise and descend by means of an elevator (not shown).

With use of the molding machine of the above structure, the molding method of the present invention provides the molded article 50 in the following manner.

While the molds 1, 2 are open, non-woven fabric 51 is wrapped over the core pin 3 and fitted thereon by suction of the suction/blower device 6. Later, the parison transfer device 4 supplies the parison 42 downwardly between the molds 1, 2 and the core pin 3, such that the parison 42 envelops the outer periphery of the non-woven fabric 51 which is fitted on the core pin 3.

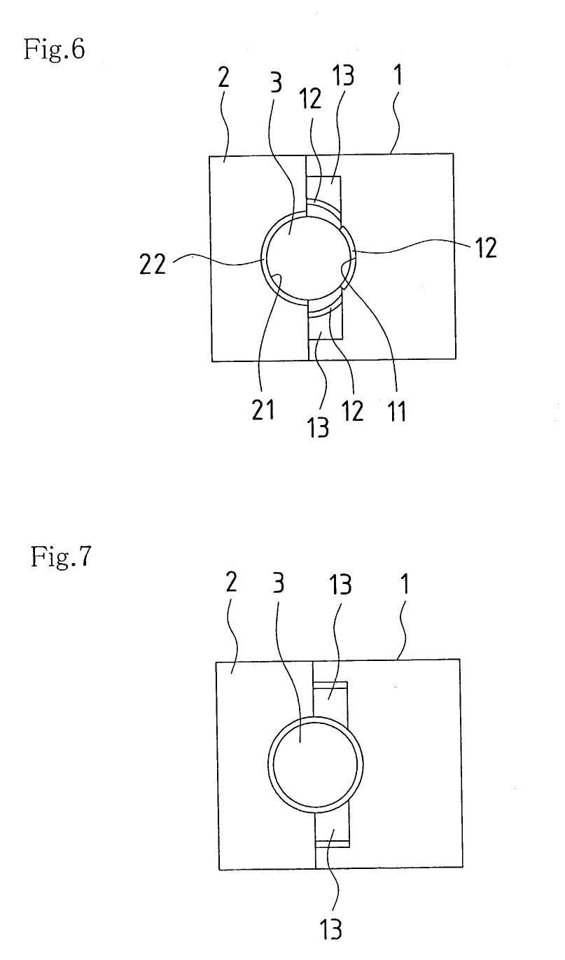

Next, with the bottom end of the parison 42 being gripped by a chuck, the parison transfer device 4 is raised until the parison 42 stretches axially to a predetermined length. When the molds 1, 2 are closed on the stretched parison, the slide members 13 in the mold 1 are arranged to remain at the retracted position as shown in FIG. 6. Accordingly, the parison 42 is sandwiched between the molds 1, 2 (excluding the slide members 13) and the core pin 3, with interposition of the non-woven fabric 51.

Later, as illustrated in FIG. 7, the slide members 13 are allowed to slide from the retracted position to the molding position closer to the core pin 3. Hence, the parison 42 and the non-woven fabric 51 are squeezed in the cavity 5 defined by the molds 1, 2 (including the slide members 13) and the core pin 3. At this stage, the suction/blower device 6 switches from the suction operation to a blowing operation for blowing air through the air holes 32 into the cavity 5. This air cools and solidifies the parison 42. After a prescribed period of time, the molds 1, 2 are opened.

To open the molds 1, 2, the slide members 13 are arranged to slide from the molding position to the retracted position, prior to the opening of the molds 1, 2. Where appropriate, the slide members 13 may be kept at the molding position during the opening of the molds 1, 2, in which case the slide members 13 are arranged to slide to the retracted position after the molds 1, 2 are open. The molding device can return to the initial state in either manner.

When the molds 1, 2 are open, the exposed molded article 50 is fitted on the core pin 3. In fact, the molded article 50 is screwed on the core pin 3 because of its special contour. To release the molded article 50 from the core pin 3, a worker manually rotates the molded article 50 and pulls it up from the core pin 3.

The molding machine of the present invention is further equipped with a drive 7 for rotating the core pin 3, as outlined by two-dot chain lines in FIG. 3. The drive 7 rotates the core pin 3 in such a manner that the core pin 3 descends by way of its spiral groove 31. According to this arrangement, while the molded article 50 is held by a removing device or the like, the molded article 50 can be released from the core pin 3 by rotating the core pin 3 with the drive 7. Thus, motor-driven rotation of the core pin 3 enables automation of the process for removing the molded article 50 from the core pin 3. For this release operation, the core pin 3 may not be necessarily lowered but be simply rotated, with the molded article 50 held by a removing device or the like. In this case, the molded article 50 can be released from the core pin 3 by being pulled up.

The thus obtained molded article 50 has two laminated layers composed of an inner layer of nonwoven fabric 51 and an outer layer of synthetic resin 52. Since the molds are closed on a pre-stretched parison, the above molding method can provide a high-quality molded article 50 which has an even wall thickness and a wrinkle-free surface or the like.

In use, this molded article 50 can connect ends of adjacent pipes, with high waterproof performance deriving from the inner layer of non-woven fabric 51.

Notably, there are many advantages in producing such a two-layer cylindrical molded article 50 by utilizing a parison-based technology. Firstly, it is possible to reduce the total molding cost by cutting the production cost of the molds and the like. Secondly, it is easy to change the shape of the molded article 50. Thirdly, due to remarkable mold release characteristics and overall moldability, it is possible to improve the yield of the molded article 50.

To sum up, the present invention provides a molding machine and a molding method for a hollow article, as a novel technique which combines the parison-based blow molding method with elements of the press molding method based on the molds 1, 2 and the core pin 3. This combination establishes a molding technique which is distinguished from the known injection molding methods.

As the hollow article, it is understood that the cross-sectional configuration does not always have to be circular as in the above embodiment. As far as the hollow article includes a cavity inside, any cross-sectional configuration is applicable. For example, the cross-sectional configuration of the hollow article may be elliptic, polygonal (e.g. triangular, quadrilateral), and others.

Additionally, the hollow article may be a simple cylinder which has neither the groove 53 nor the ridge 54 along the inner and outer peripheral surfaces. In this case, the molds 1, 2 do without the ridges 12, 13, and the core pin 3 omits the groove 31.

In the above embodiment, the parison is stretched by upward movement of the parison transfer device 4. Conversely, the parison may be stretched by downward movement of the core pin 3, with the parison transfer device 4 being fixed. It is additionally noted that the parison stretching step is not essential and may be omitted.

The number of slide members 13 can be arranged according to the shape of the molded article or other factors. The slide members 13 can be disposed on the first mold 1 as in the above embodiment, or on the second mold 2 or on both of the molds 1, 2. As for the moving unit which makes up a part of the molding surface, the slide members 13 may be arranged to move to and away from the core pin 3, not only in a sliding manner but also in a rotating manner or any other manner.

The material of the bottom layer is not limited to the non-woven fabric 51 but selectable according to the intended use of the molded article. Even in terms of waterproof performance alone, there are many practicable materials in addition to the non-woven fabric 51.

Besides, this invention can provide a molded article having three or more layers. The multi-layer structure can be made by fitting two types of bottom layer materials around the core pin 3 in advance, or by supplying parisons in two or more layers.

As the means for fitting the non-woven fabric 51 on the core pin 3, this embodiment utilizes the suction/blower device 6. However, the non-woven fabric 51 may be fitted on the core pin 3, without the aid of the suction/blower device 6. In this case, the molding machine dispenses with the suction/blower device 6, the air holes 32 and other relevant constituents. Likewise, the molding method skips the blowing operation from the suction/blower device 6 to the cavity 5.

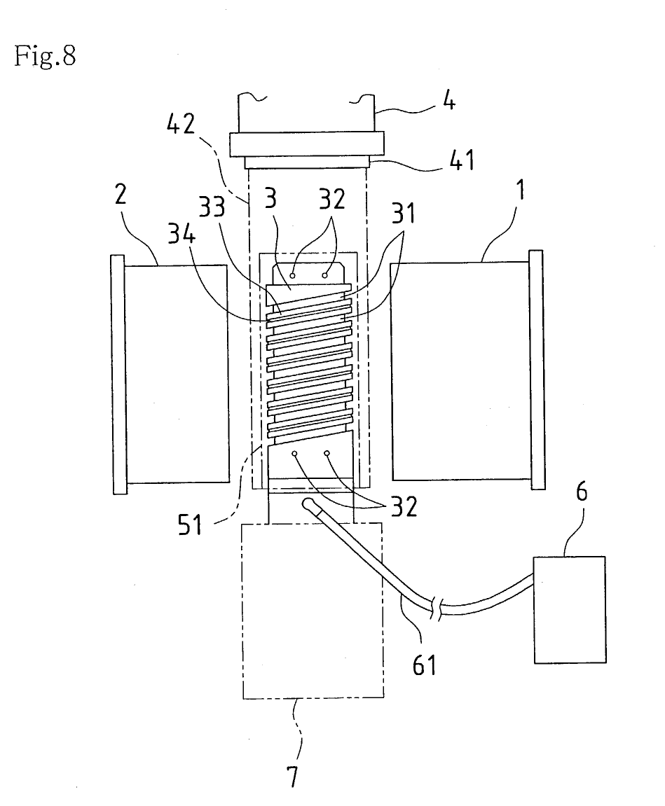

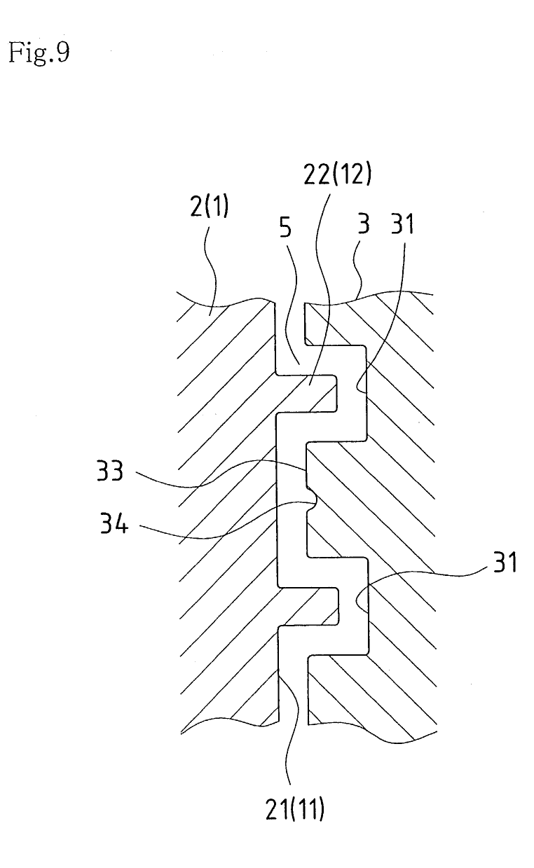

FIG. 8 and FIG. 9 show another molding machine for producing a modified molded article, based on the molded article 50 in the first embodiment.

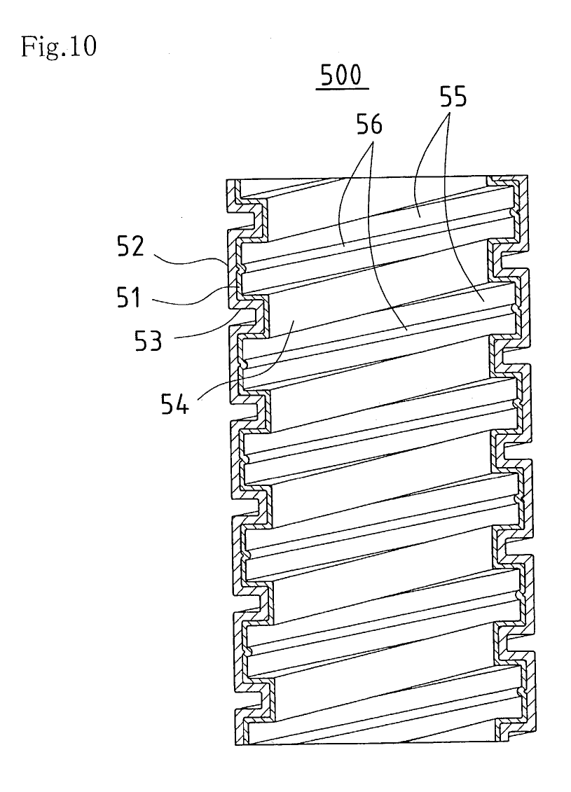

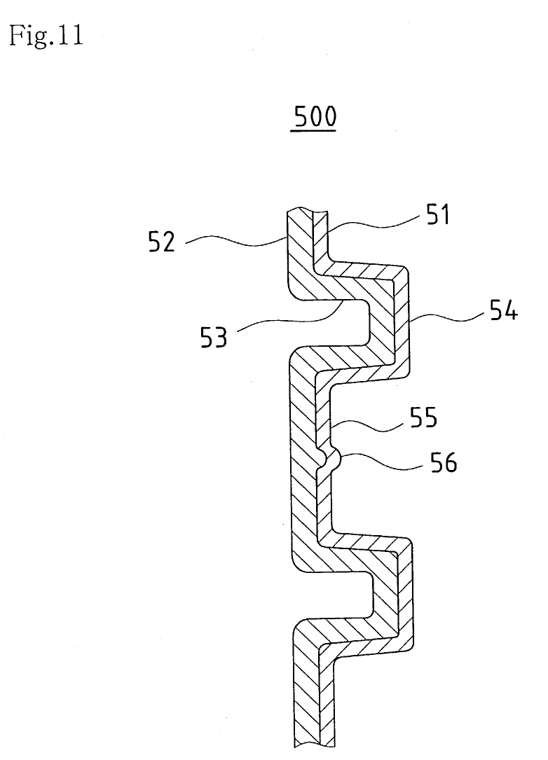

While the molded article 50 includes the groove 55 as a thread, the molded article 500 has an additional spiral ridge 56 which is formed on and extends along the bottom surface of the groove 55, as illustrated in FIG. 10 and FIG. 11. This being the only difference between the molded article 500 and the molded article 50, common constituents are indicated by identical signs to omit the detailed description.

As for the molding machine for this molded article 500, the core pin 3 has an additional groove 34 which is formed in the top surface of the spiral ridge 33 defined between adjacent spires of the groove 31.

The additional groove 34 spirally extends along the top surface of the ridge 33. Just as the ridge 33 shapes the groove 55 in the molded article 500, the additional groove 34 in the ridge 33 serves to shape the additional ridge 56 which extends along the groove 55 in the molded article 500.

In the core pin 3, the air holes 32 are arranged only in the upper and lower parts. Except for these arrangements, the molding machine of the modified embodiment has the same structure as stated in the previous embodiment. Hence, common elements are indicated by identical signs to omit the detailed description. Using this molding machine, the molded article 500 can be molded according to the same molding method as already mentioned.

Thus, the molded article 500 of the modified embodiment is provided with the additional ridge 56 in the groove 55. When this molded article 500 is screwed on ends of two pipes in order to connect them, the molded article 500 and the pipe ends establish linear contact via the additional ridge 56, instead of surface contact. Namely, the pipe ends can be screwed into the molded article 500 with a minimum contact area, and thus with a minimum friction resistance. Consequently, the modified embodiment realizes a simple pipe connection operation with a smooth screwing step.

Furthermore, the additional ridge 56 may be squashed when the pipe ends are screwed into the molded article 500. In this case, even if the fitting dimension of the pipe ends does not exactly match that of the molded article 500, the squashed ridge 56 acts to compensate for this discrepancy. Since this arrangement eases the dimensional precision between the molded article and the pipe ends, it is possible to achieve improved moldability.

In this modified embodiment, the additional ridge 56 extends along the groove 55 continuously and without interruption. Nevertheless, the additional spiral ridge 56 may be formed intermittently at a certain interval. To shape the additional spiral ridge 56 in an intermittent manner, the additional groove 34 is arranged intermittently in the top surface of the ridge 33.

The invention may be embodied in other specific forms without departing from the spirit or essential characteristics thereof. The above embodiments are therefore to be considered in all respects as illustrative and not restrictive, the scope of the invention being indicated by the appended claims rather than by the foregoing description. All changes which come within the meaning and range of equivalency of the claims are therefore intended to be embraced therein.

This application is based on Patent Application Nos. 2001-391707 and 2002-300152 filed in Japan, the contents of which are incorporated hereinto by reference. Likewise, the contents of all references cited herein are incorporated hereinto by reference.

What is claimed is:

1. A molding machine for a hollow article which has at least two laminated layers, which comprises:
a pair of molds which are capable of opening and closing;
a core pin which is disposed between the molds and which allows a bottom layer material to fit on a peripheral surface of the core pin;
a parison transfer device which supplies a parison, as a top layer material, between the bottom layer material and the molds; and
a moving unit which is disposed in at least one of the molds and which moves to and away from the core pin,
wherein the pair of molds, the moving unit and the core pin are arranged to define a space which corresponds to the hollow article, when the molds are closed.

2. The molding machine for a hollow article according to claim 1, wherein the peripheral surface of the core pin includes a spiral groove, and inner surfaces of the molds and the moving unit have a spiral ridge to be received and engaged by the spiral groove.

3. The molding machine for a hollow article according to claim 1 or 2, wherein the moving unit is composed of a pair of slide members which are slidable to and away from the core pin.

4. The molding machine for a hollow article according to claim 2, wherein a spiral ridge is defined between adjacent spires of the groove formed in the core pin, and a top surface of this spiral ridge is provided with an additional groove which extends continuously or intermittently along the ridge.

5. The molding machine for a hollow article according to claim 3, wherein a spiral ridge is defined between adjacent spires of the groove formed in the core pin, and a top surface of this spiral ridge is provided with an additional groove which extends continuously or intermittently along the ridge.

6. A molding method for a hollow article which has at least two laminated layers, which comprises the steps of:
placing and fitting an annular bottom layer material on a peripheral surface of a core pin which is disposed at the center of a pair of molds;
supplying a parison around an outer periphery of the bottom layer material so as to enclose the core pin and the bottom layer material by the parison;
closing the molds, except a moving unit which is provided in at least one of the molds, thereby making a partially interrupted molding surface; and
moving the moving unit in order to complete the molding surface, thereby molding a hollow article.

7. The molding method for a hollow article according to claim 6, which further comprises the step of stretching the parison in an axial direction, with an end of the parison gripped,
the stretching step being performed between the parison supply step and the mold closing step.

8. The molding method for a hollow article according to claim 6 or 7, which further comprises:
forming a spiral groove in the peripheral surface of the core pin; and
providing a spiral ridge to be received and engaged by the spiral groove, on inner surfaces of the molds and the moving unit,
in such a manner that the hollow article, when molded, has a spiral groove formed in an outer peripheral surface thereof and a spiral ridge formed on an inner peripheral surface thereof.

9. The molding method for a hollow article according to claim 8, wherein the molded hollow article is released from the core pin by rotating the core pin.

10. The molding method for a hollow article according to claim 6, 7 or 9, wherein the bottom layer material is a material having waterproof performance.

11. The molding method for a hollow article according to claim 8, wherein the bottom layer material is a material having waterproof performance.
